(19) United States
(12) Patent Application Publication
(10) Pub. No.: US 2005/0177852 A1
(43) Pub. Date: Aug. 11, 2005

(54) Computer optical disc drive having plug and video/audio broadcasting and digital recording method thereof

(76) Inventor: Ching-Jim Lin, Chu Pei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/774,508

(22) Filed: Feb. 10, 2004

(51) Int. Cl. H04N 7/173; H04N 7/18

(52) U.S. Cl. 725/80; 725/81; 725/100; 725/131

(57) ABSTRACT

A computer optical disc drive and video/audio broadcasting and digital recording method thereof is described. The computer optical disc drive has a plug located outside of the main body of the optical disc drive and the plug is connected to a first interface connector electrically connecting to the circuit board of the main body of the optical disc drive. The plug may have a network connection card inserted at the time the optical disc drive plays video/audio data and thus transmit the video/audio data in the wireless manner to the receiver. Or the plug may further have video/audio multi-media card inserted when the optical disc drive performs digital recording, thereby the multi-media card would receive the video/audio data output from the video/audio broadcasting device and compress and transmit them to the optical disc drive.

### BACKGROUND OF THE INVENTION

1. Field of the Invention

The present invention relates to an optical disc drive having a plug and video/audio broadcasting and digital recording methods thereof, and more particularly, to an optical disc drive with a plug for computer use.

2. Description of the Prior Art

Conventional computer optical disc drives mainly provide functions of optical disc playing and recording, making disc drives more and more likely to be installed in audio/video appliances. However, these optical disc drives require a variety of procedures such as turning on computers, loading operating systems and executing corresponding programs to initiate, meaning current optical disc drives are of no use without a power supply or corresponding program execution. Furthermore, when users want to record video/audio data through computers, video/audio data retrieval cards are necessary and installation thereof further requires opening the computer case, making the use of these kinds of optical disc drives more burdensome.

### SUMMARY OF THE INVENTION

It is therefore a primary objective of the present invention to provide a computer optical disc drive with a plug and video/audio broadcasting and digital recording methods with the use of the optical disc drive according to the present invention. Under the present configuration, inserting utility cards of different purposes into the plug of the optical disc drives provides a solution to conventional optical disc drives.

In accordance with the claimed invention, a computer optical disc drive includes a main body having a disc module and a circuit board for controlling operations of the disc module, and a plug positioned outside the main body. The plug utilizes a first interface connector connected to the circuit board so as to have utility cards connected to the circuit board through the first interface connector after the utility cards are inserted into the plug.

It is an advantage of the present invention that a video/audio broadcasting system includes the present invention computer optical disc drive, a receiver for receiving a network connection card inserted into the plug of the optical disc drive and a television connected to the receiver for having the received video/audio data output.

Additionally, with the adoption of the present invention computer optical disc drive, a digital recording system further includes a video/audio broadcasting device and a video/audio multi-media card for receiving video/audio data from the video/audio multi-media card, so as to facilitate following data recording procedures.

The present invention further provides methods of video/audio broadcasting and digital recording with the use of the present invention optical disc drive and other associated devices.

These and other objectives of the present invention will undoubtedly become obvious to those of ordinary skill in the art after reading the following detailed description of the preferred embodiment that is illustrated in the various figures and drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a schematic diagram of an optical disc drive according to the present invention;

FIG. 2 is a circuit block diagram of the optical disc drive according to the present invention;

FIG. 3 is another circuit block diagram of the optical disc drive according to the present invention;

FIG. 4 is a schematic diagram illustrating a video/audio broadcasting system adopting the optical disc drive of the present invention; and

FIG. 5 is a schematic diagram showing a digital recording system using the optical disc drive according to the present invention.

### DETAILED DESCRIPTION OF THE PREFERRED EMBODIMENT

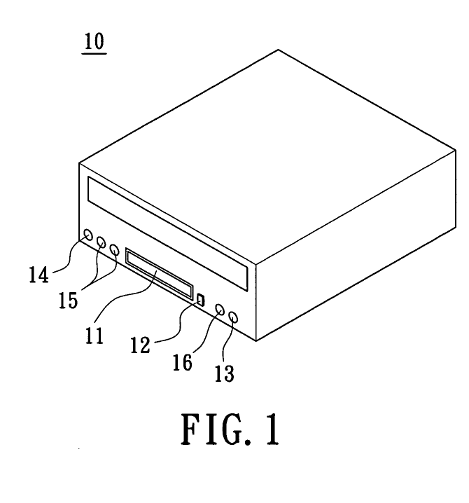

Reference is made to FIG. 1, a schematic diagram of a computer optical, disc drive according to the present invention. The major difference between the present invention and conventional computer optical disc drives is the setting of the plug. The optical disc drive 10 includes a plug 11 and an ejection switch 12 for ejecting the utility card inserted into the plug 11. As shown in FIG. 1, the plug 11 and ejection switch 12 are located on the front side plate of the main body of the optical disc drive. The plug is compatible with the specification of personal computer memory card international association (PCMCIA).

In addition to the plug 11, the optical disc drive 10 further includes a power jacket 13 and the external power supplies to the optical disc drive 10 through the power jacket 13 even the computer itself is shut down. The optical disc drive in this case refers to the optical disc drive inside the computer case. With the insertion of utility cards, a user may control the optical disc drive 10 through configurations of these utility cards. The present invention computer optical disc drive also includes an earphone plug 14, switch (or turning button) 15, and indicator 16, just the same as those in conventional one. For the purpose of having the newly added plug 11, ejection switch 12 and power jacket 13 smoothly operate, optical disc drive 10 adds corresponding control circuitry on the circuit board.

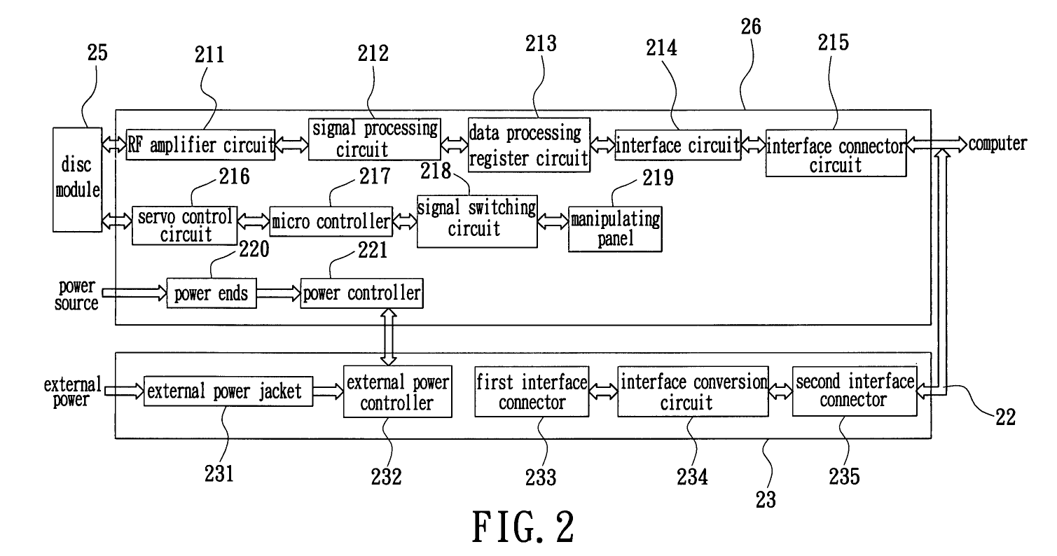

Reference is made to FIG. 2, a circuit block diagram according to the present invention. FIG. 2 can be divided into three parts as follows: disc module 25, circuit board 21 and interface plate 23. Both the disc module 25 and circuit board 21 are primary parts of the present invention and conventional optical drives. The circuit board 21 is for controlling operations, such as tracking and focusing of optical disc, of the disc module 25. The circuit board 21 includes RF amplifier circuit 211, signal processing circuit 212, data processing register circuit 213, interface circuit 214, interface connector 215, servo controller 216, micro controller 217, signal switching circuit 218, manipulating panel 219, power connector 220 and power controller 221. The circuit board 21 controls the disc module in a conventional manner.

Interface plate 23 is for the use of external circuit and fixed within the optical disc drive 10. Interface plate 23 includes an external power jacket 231, external power controller 232, first interface connector 233, interface conversion circuit 234 and second interface connector 235. The external power jacket 231 is for the input of external power and the external power controller 232 connects to the power controller 221 of the circuit board 21. The external power controller 232 therefore converts the external power inputs into voltages suitable for the circuit board 21.

The first interface connector 233 is compatible with PCMCIA specification in this embodiment; however, it can be compatible with the specifications for Mini-PCI, IEEE-1394, or USB. The first interface connector 233 is within the plug 11, so as to have utility cards mutually connect with the first interface connector 233.

Interface conversion circuit 234 connects the first and second interface connectors 233 and 235 and makes specifications of the first interface connector 233 compatible with those of the second interface connector 235. The second interface connector 235 connects to the interface connector 215 of the circuit board 21. The second interface connector 235 is compatible with specifications for IDE, E-IDE, ATA/ATAPI and SCSI.

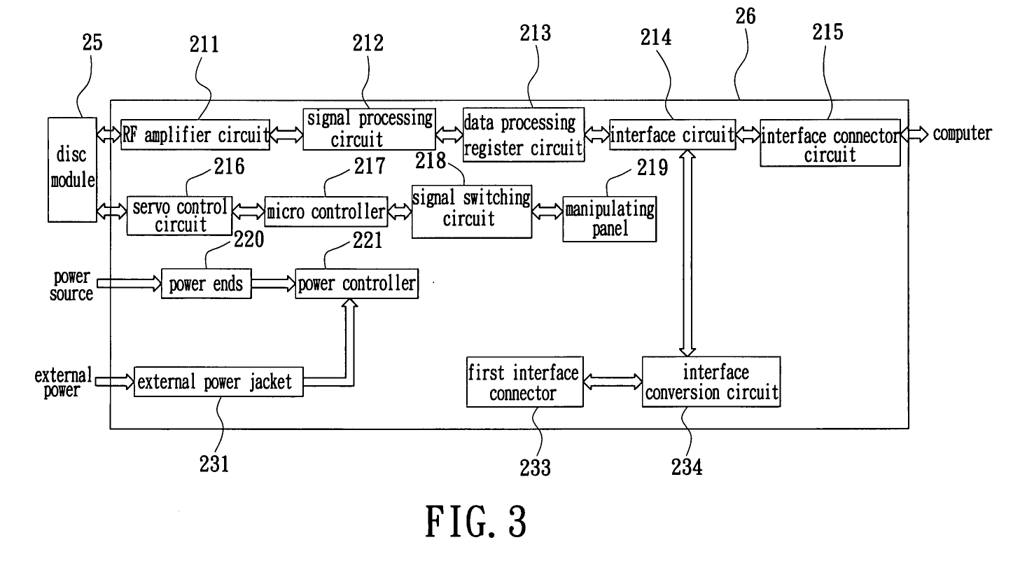

Reference is made to FIG. 3, another circuit block diagram for the present invention optical disc drive. Newly added circuitry in FIG. 2 is placed on the interface plate 23, while the same one is integrated with the circuit board 26 so as to simplify the whole structure and reduce costs without drastic change to the previous configuration. Newly added circuitry on the circuit board 26 includes the external power jacket 231. First interface connector 233 and interface conversion circuit 234 connect the first interface connector 233 and interface circuit 214 to make specifications of the first interface connector 233 compatible with those of the circuit board 26.

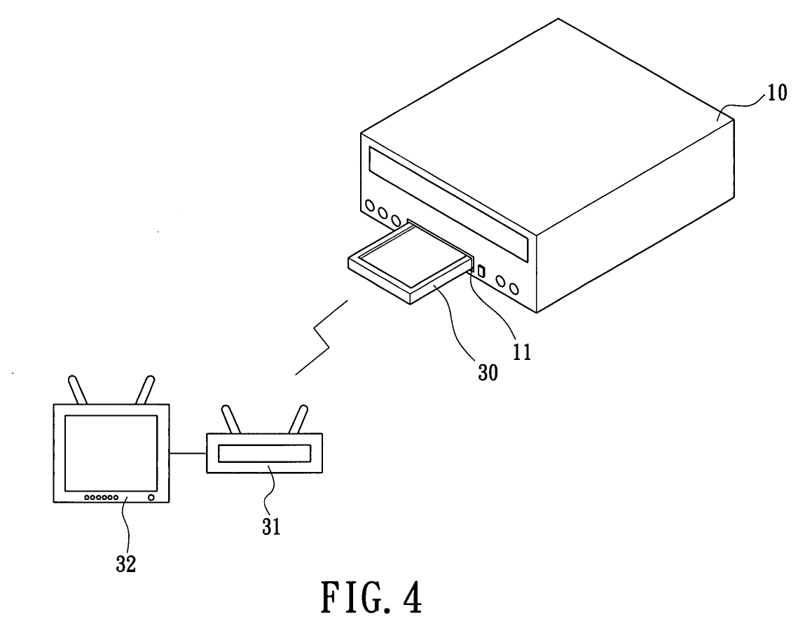

Reference is made to FIG. 4, a schematic diagram of having the present invention optical disc drive integrated with a utility card such as a network connection card or multi-media card to constitute a video/audio broadcasting system. The video/audio broadcasting system includes the optical disc drive 10, wireless network connection card 30, receiver 31 and a television 32. The optical disc drive 10 can be selectively placed within the computer or in a study or living room. The power supply to the optical disc drive 10 comes from the power fore the computer or external power. Setting the firmware of the wireless (or wired) network connection card 30 controls the optical disc drive and provides video/audio compression. The network connection card 30 serves as a data transmission media between the optical disc drive 10 and receiver 31, which receives digital compressed video/audio signals in a wireless manner and decompresses the same into standard or high-resolution television signals. The television 32 connects to the receiver 31 to output the decompressed video/audio signals received by the receiver 31.

As long as the video/audio optical disc 10 is placed within the optical drive, users may insert the wireless network connection card 30 into the plug 11 and make sure that the wireless network connection card 30 is connected to the first interface connector 233. Then, if the optical drive is turned on to play the video/audio optical disc, the wireless network connection card 30 automatically reads the broadcasted video/audio data from the optical disc 10 and wirelessly transmits the data to the receiver 31. Even if the computer is shut down, once the external power is available to the optical disc drive 10, the video/audio data from the optical disc can be wirelessly transmitted to the receiver 31. In the wake of receiving the video/audio data, the receiver 31 decompresses the data and outputs the same to the television 32.

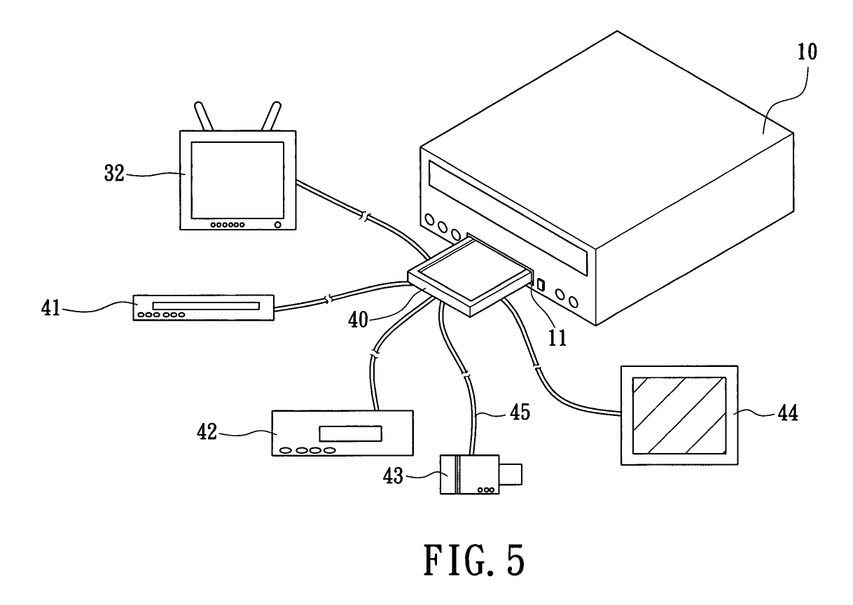

Reference is made to FIG. 5, a schematic diagram illustrating a digital recording system adopting the present invention optical drive. The digital recording system includes an optical disc drive 10, a video/audio broadcasting device and a video/audio multi-media card 40. The video/audio broadcasting device is a television 32, set-top box 44, video/audio optical disc player, cassette-type player/recorder 42 or camera 43. Firmware of the multi-media card 40 may control the optical disc drive (with the function of data recording) to perform data recording. The multi-media card 40 further includes compression and decompression units for video and audio signals. The compression and decompression units for video signals are compatible with specifications for JPEG, JPEG2000, Motion-JPEG, Motion-JPEG2000, H.263, H.263+, H.264 and MPEG-1/2/4, while the same units for audio signals are compatible with specifications for MPEG Layer 1/2/3, AC-3, AAC and DTS. Ends of the multi-media card 40 are compatible with AV-type, S-type, RGB-type, YPbPr-type, YCbCr-type, microphone-type and SPDIF-type specifications.

If any video/audio data are to be stored into the optical disc, users may choose to insert the video/audio multi-media card 40 into the plug 11 of the optical disc drive 10 and place the optical disc within the optical disc drive. By connecting the multi-media card 40 and video/audio broadcasting device through wire cable 45 and turning on the video/audio broadcasting device, as long as the optical disc drive is turned on, the multi-media card automatically compresses video/audio data in the course of broadcasting and records on the recordable optical disc by the optical disc drive 10.

In contrast to prior art, the present invention computer optical disc drive expands its functions by having the utility card insert into the plug, upgrading the simple optical disc drive to a digital recorder or a wireless video/audio broadcaster, and working independently without the use of a computer by use of the external power supply and control by the utility card.

Those skilled in the art will readily observe that numerous modifications and alterations of the device may be made while retaining the teachings of the invention. Accordingly, the above disclosure should be construed as limited only by the metes and bounds of the appended claims.

1. A computer optical disc drive comprising:
a main body having a disc module and a circuit board for controlling operations of the disc module; and
a plug positioned outside of the main body and having a first interface connector connected to the circuit board.

2. The computer optical disc drive of claim 1, further comprising a power jacket for having external power input to the circuit board.

3. The computer optical disc drive of claim 2, wherein the power jacket further comprises an external power controller therein so as to connect the external power to the circuit board.

4. The computer optical disc drive of claim 1, wherein the plug is compatible with the specification of personal computer memory card international association (PCMCIA).

5. The computer optical disc drive of claim 1, further comprising an interface conversion circuit electrically connecting the first interface connector and the circuit board for interfacing the first interface connector and the circuit board.

6. The computer optical disc drive of claim 5, wherein the first interface connector is compatible with and selected from PCMCIA, Mini-PCI, IEEE 1394, and USB specifications.

7. The computer optical disc drive of claim 5, further comprising a second interface connector connected to the interface conversion circuit and the circuit board through a bank wire.

8. The computer optical disc drive of claim 7, wherein the second interface connector is compatible with and selected from IDE, E-IDE, ATA/ATAPI, and SCSI specifications.

9. The computer optical disc drive of claim 1, further comprising an ejection switch for ejecting a card inserted into the plug.

10. A video/audio broadcasting system, comprising:
a computer optical disc drive having a main body, wherein the main body includes a disc module and a circuit board for controlling operations of the disc module, and a plug positioned outside of the main body and having a first interface connector electrically connected to the circuit board;
a network connection card inserted into the plug and connected to the first interface connector for retrieving audio and video data from the main body;
a data receiver for receiving the audio and video data retrieved by the network connection card; and
a television connected to the receiver for displaying the audio and video data received by the receiver.

11. The video/audio broadcasting system of claim 10, wherein the network connection card is either a wired or wireless type.

12. The video/audio broadcasting system of claim 10, further comprising an audio/video data disc placed within the main body of the computer optical disc drive.

13. A digital recording system, comprising:
a computer optical disc drive having a main body, wherein the main body includes a disc module and a circuit board for controlling operations of the disc module, and a plug positioned outside of the main body and having a first interface connector electrically connected to the circuit board;
a video/audio broadcasting device; and
a video/audio multi-media card inserted into the plug and connected to the first interface connector for retrieving audio and video data from the video/audio broadcasting device and outputting the audio/video data to the computer optical disc for data recording.

14. The digital recording system of claim 13, wherein the video/audio broadcasting device is a television, digital video/audio computer optical disc player, cassette type recorder/displayer, camera, or set-top box.

15. The digital recording system of claim 13, wherein the video/audio multi-media card is compatible with a video specifications including H.263, H.263+, H.264, MPEG, JPEG, JPEG-2000, Motion-JPEG, and Motion-JPEG2000.

16. The digital recording system of claim 13, wherein the video/audio multi-media card is compatible with audio specifications including MPEG Layer 1/2/3, AC-3, AAC, and DTS.

17. The digital recording system of claim 13, further comprising a wire cable connected between the video/audio broadcasting device and video/audio multi-media card.

18. The digital recording system of claim 17, wherein the wire cable includes ends of AV-type, S-type, RGB-type, YPbPr-type, YCbCr-type, or microphone-type, SPDIF-type.

19. The digital recording system of claim 15, further comprising a recordable optical disc placed within the main body of the computer optical disc drive.

20. A video/audio broadcasting method, comprising:
providing a computer optical disc drive with a plug;
playing a video/audio optical disc within the computer optical disc and outputting video/audio data of the video/audio optical disc through a network connection card inserted into the plug;
receiving the video/audio data of the video/audio optical disc with a receiver; and
displaying the received video/audio data on a television.

21. The video/audio broadcasting method of claim 20, wherein the network connection card is for transmitting the video/audio data to the receiver in a wired or wireless manner.

22. The video/audio broadcasting method of claim 20, wherein the receiver is for receiving the wired or wireless video/audio data and then decoding the received compressed video/audio data into standard or hi-resolution television signals.

23. A digital recording method, comprising:
providing a computer optical disc drive with a plug;
receiving output signals of a video/audio broadcasting device through a video/audio multi-media card inserted into the plug; and
recording the output signals from the video/audio multi-media card into a recordable disc by the computer optical disc drive.

24. The digital recording method of claim 23, wherein the video/audio multi-media card further includes compression and decompression units for video and audio signals.
